(19) United States
(12) Patent Application Publication
(10) Pub. No.: US 2002/0194092 A1
(43) Pub. Date: Dec. 19, 2002

(54) Method and system for selling items, and a device for presentation of a purchased item

(76) Inventors: Gabriel Tolkowsky, Antwerpen (BE); Gideon Tolkowsky, Herzliya (IL); Uri Tolkowsky, Netanya (IL)

Correspondence Address: GREER, BURNS & CRAIN, LTD., Suite 2500, 300 S. Wacker Drive, Chicago, IL, 60606, US

(21) Appl. No.: 10/134,962

(22) Filed: Apr. 29, 2002

Related U.S. Application Data
(60) Provisional application No. 60/287,453, filed on Apr. 30, 2001.

(51) Int. Cl. G06F 17/60

(52) U.S. Cl. 705/27

(57) ABSTRACT

A method and system for selling items are presented, as well as a device for the presentation of a purchased item. A purchaser of a specific item is allowed to choose information to be included in purchase-related data associated with this specific purchase, and for selecting a manner in which the purchase-related data is to be presented to the purchaser or another person for whom the item is being purchased. At least one predetermined output representative of the purchase-related data is then created and formatted in the manner of presentation thereof selected by the purchaser. The presentation case comprises a data representing utility operable to cause the presentation of the predetermined output form the presentation case itself or from an external data-retrieving device.

### FIELD OF THE INVENTION

The present invention relates to a method and system for selling items, and a device for the presentation of a purchased item.

### BACKGROUND OF THE INVENTION

It is common procedure to sell an item selected by a purchaser by supplying the item in a presentation case, which is typically formed with the trademark of the item manufacturer and/or seller. It is also known to provide such expensive items as gemstones and jewelry pieces with a certificate specific for the purchased item, wherein the certificate typically includes specific parameters of the gemstone or jewelry piece.

With regard to gemstones, particularly diamonds, it has been found that each diamond is characterized by a unique optical signature, namely, a light response (pattern) to predetermined incident radiation. Hence, the diamond can be identified by the light response thereof. The Gemprint Corporation markets a system and manages a database where the optical responses of gemstones are determined and recorded in the database for future reference. The certificate related to a specific diamond may include a printed image of the bitmap corresponding to the detected optical response of this specific diamond. Systems for classifying and identifying gemstones are disclosed, for example, in U.S. Pat. Nos. 5,124,935 and 5,828,405.

Thus, an item can be purchased with an item identification code (manufacturer/seller trademark, optical signature, etc.). If the item is purchased as a gift, it can be supplied with a separate congratulatory message prepared by the purchaser of the item, and be either attached to the item or written thereon, as the case may be.

### SUMMARY OF THE INVENTION

There is a need in the art to facilitate the sale of items by providing a novel method and system for selling items, and a device for the presentation of a purchased item. The main idea of the present invention consists of enabling a purchaser of an item to create specific purchase-related data, which may and may not include the item-related data, and select a manner of presentation of the purchase-related data.

The purchase-related data may include personal information of the purchaser of an item, personal information of the receiver of an item (a person for whom the item has been purchased as a gift), or information associated with relations between the purchaser and receiver, etc. The purchase-related data is formatted in accordance with the purchaser's preferences. More specifically, the purchase-related data may be formatted for presentation (at once or periodically) in a sensory perceptible manner, such as a visual and/or audio message (and optionally also tactile), which may be presented on a personal computer or phone device of the purchaser/receiver. The purchase-related data, when being determined by the item purchaser/receiver, may be stored on a suitable information carrier supplied together with the item and enabling the presentation of this data whenever the purchaser/receiver desires, or may be transmittable to a data presentation device (computer, phone) through a communication network. The purchase-related data may additionally or alternatively include a scent (perfume).

In other words, the purchaser of a selected item is invited to select information to be included with the purchase in the purchase-related data, for example, by mining a database maintaining reference data prepared by the item seller, and possibly adding additional data or vary the selected reference data in accordance with the purchaser/receiver preferences. For example, when purchasing an item to be presented as a gift to the item receiver on his/her birthday, the purchaser may select corresponding astrological data (e.g., data concerning the position of stars at the receiver's home-place and on his birthday) to be included in the purchase-related data.

The purchaser may select the item-related data to be included in the purchase-related data. The item-related data may include the particulars of item manufacturer and/or item seller, and/or the specific signature of a purchased item. The specific signature of an item is actually data indicative of one or more parameters characterizing either a specific item (unique signature), or an item of a specific kind (e.g., items that are reproducible and are therefore characterized by the similar parameter(s)). The unique signature may, for example, be indicative of a light response of the item to predetermined incident light, due to the unique structure of the item (e.g., reflection and refraction characteristics of the structure.

Generally speaking, an item to be sold may be of the kind provided with an identification code (incorporated in or attached thereto), the code being indicative of the item- and/or item-manufacturer- and/or item-seller-related data. For example, the item may carry the item-manufacturer trademark incorporated in the item. A method of selling such an item enables various options of the item presentation to a receiver of the item.

Thus, according to one aspect of the present invention, there is provided a method of selling items, the method comprising the steps of:

(a) allowing a purchaser of a specific item to choose information to be included in purchase-related data associated with this specific purchase, and for selecting a manner in which the purchase-related data is to be presented to the purchaser or another person for whom the item is being purchased; and

(b) creating a predetermined output representative of the purchase-related data and formatted in the manner of presentation thereof selected by the purchaser.

The choosing of the information to be included in the purchase-related data may comprise selecting one or more information pieces from a database containing reference data including various information pieces prepared by a seller (retailer) of the items. This database may be located remote from a purchaser site, as well as remote from a seller site, and accessible through a communication network. If the purchase-related data includes a fragrance, a suitable system is provided at the seller site such as the known Digital Aroma Generation system developed by AromaJet.com, USA (see Internet WebSite Aromajet.com). Generally, if searching in the previously prepared database is considered, the database may be located at the seller site, at a remote site or be the so-called distributed database having different portions maintained at different sites and accessible through a communication network. Thus, for example, the purchaser may select a perfume at the seller site, and access the database to search for other pieces of information to be included in the purchase-related data at the seller site, from the seller site or from his personal communication device.

The purchaser may select that the output representative of the purchase-related data is to be stored on an information carrier (e.g., disc or card) readable by an external device such as a personal computer. In this case, the seller prepares an information carrier with the predetermined output recorded therein and supplies the information carrier to the purchaser.

The purchaser may select that the entire output representative of the purchase-related data or a data portion thereof is to be transmitted to a personal communication device of the purchaser or another person (item receiver) through a communication network to be retrieved whenever the purchaser/receiver desires. In this case, the seller prepares a data package containing the selected output or data portion thereof formatted for transmission through the communication network. If the purchaser desires, the data package may be preprogrammed to provide periodic presentation of the purchase-related data.

The purchaser may select that the output representative of the purchase-related data or a data portion thereof is to be retrievable via a presentation case containing the purchased item. In this case, the seller provides the presentation case equipped with a data representing utility, which includes an information carrier with the output or portion thereof stored in the carrier and also a data output utility. Thus, when the data representing utility is operated, it causes the generation of the output or a portion thereof. The portion of the output may be a fragment thereof enabling access to the entire output at the external device (e.g., computer) in response to the portion of the output generated by the data output utility.

According to another aspect of the present invention, there is provided a system for selling items comprising:

(a) a user interface utility enabling a purchaser to define information which is to be included in purchase-related data associated with a specific purchase of an item selected by a purchaser of the item; and

(b) a data processing utility for creating a predetermined output representative of the purchase-related data in accordance with the defined information, and formatting the output in the manner of presentation thereof selected by the purchaser.

Preferably, the system also comprises at least one database containing various pieces of information, for selecting and defining at least one piece of information to be included in the purchase-related data through the user interface utility. These pieces of information may include various types of congratulatory messages, perfumes, etc. If more than one database is to be used to define the purchase-related data, the system utilizes suitable software for combining data from various (mutually incompatible) databases.

According to yet another aspect of the present invention, there is provided a device for the presentation of a purchased item to be supplied to a purchaser of the item, the device comprising a data representing utility, which, when being operated, causes the generation of a predetermined output or a portion thereof, wherein said predetermined output is representative of purchase-related data that has been chosen by the purchaser of the item.

According to yet another aspect of the present invention, there is provided a presentation case for containing a purchased item, the presentation case being provided with a data representing utility, which, when being operated, causes the generation of a predetermined output or a portion thereof, wherein said predetermined output is representative of purchase-related data that has been chosen by the purchaser of the item.

If the purchased item is of the kind characterized by a specific signature (e.g., specific physical parameter or any reference mark incorporated in or attached to the item), the data representing utility may also comprise a verification assembly for verifying this specific signature to thereby enable identification and authentication of the purchased item contained in the presentation case. To this end, the verification assembly comprises a measuring unit of the kind capable of determining a discriminating characteristic of the item defining the specific signature and generating data indicative thereof, and a data processing and analyzing utility. The measuring unit may include an optical system (composed of a radiation source and a detector) for determining the light response of the item and/or reading an identification code assigned to the item and incorporated in or attached to the item. The measuring unit may be of the kind capable of determining any other character of the item, such as its weight, moment of inertia, resonance condition. etc. The data processing and analyzing utility of the verification assembly may be preprogrammed such as to allow the presentation of the predetermined output or a portion thereof, only if the data generated by the measuring unit matches at least a part (fragment) of the specific signature. In other words, the measured character of the item presents a key code to the predetermined output representative of the purchase-related data.

It is important to note that the present invention, due to the provision of the purchase-related data including audio data and/or a scent, provides for visually impaired or blind people to enjoy such a wonderful purchase or gift.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 illustrates pieces of information to be included in a purchase-related data in accordance with the invention

FIG. 2 illustrates pieces of information to be included in item-related data;

FIG. 3 illustrates a flow chart of the main steps in a method of selling items according to the invention; and

FIG. 4 illustrates a block diagram of the main components of a system for selling items according to the invention;

FIG. 5 illustrates one possible example of the design of a database suitable to be used in the system of FIG. 4;

FIGS. 6A to 6D illustrate four possible examples, respectively, of a presentation case according to the invention.

### DETAILED DESCRIPTION OF THE INVENTION

The present invention consists of selling items by assigning to a specific purchase certain purchase-related data, which have been chosen by the purchaser, and can be presented as predetermined output as selected by the purchaser. The output may include visual and/or audio data (music, picture, text message, etc.), and also a scent. In order to select an item of interest and purchase the same, the purchaser either visits a store, or searches in respective advertising material (catalogs), which may, for example be available on the Internet, accessing a corresponding WebSite.

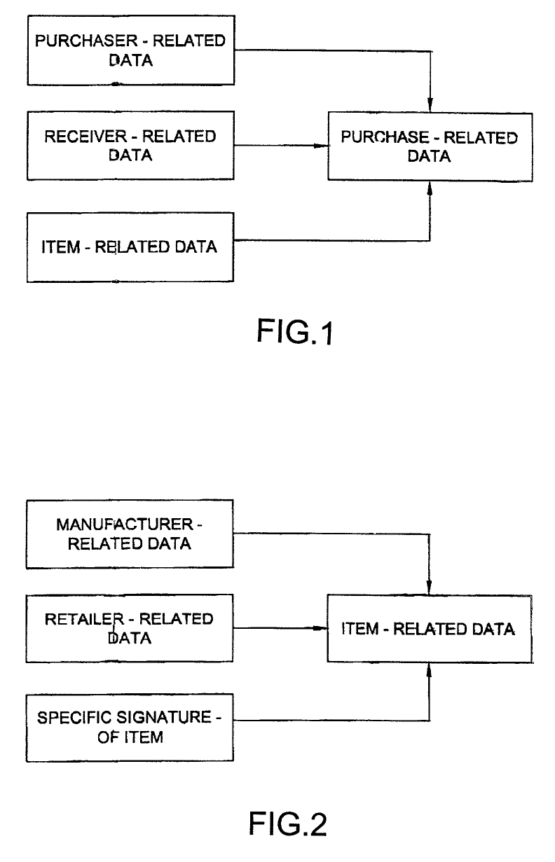

Referring to FIG. 1, there is illustrated one specific example of the purchase-related data, which includes a piece of information associated with the purchaser (purchaser-related data), a piece of information associated with a receiver of the item (receiver-related data), and a piece of information associated with the selected item (item-related data). The purchaser-related data may include the purchaser's personal data (purchaser's name, etc.) recognizable by the receiver of the item, namely, a person for whom the selected item is purchased. The receiver-related data may include the receiver's personal data and/or any indication to the relation between the purchaser and receiver. It should be understood that the purchaser might purchase the item for himself, in which case probably no item receiver is considered.

Turning now to FIG. 2, there is illustrated that the item-related data may be indicative of the item manufacturer particulars (manufacturer-related data), for example, the manufacturer trade name and/or trademark; the item seller particulars (seller-related data), and/or item specific signature associated with specific parameter(s) of the item. The manufacturer-related data, as well as the seller-related data, may be incorporated in or attached to the item in a manner to be read, for example by optical means. The specific signature of the item may be its optical response (pattern), weight, etc. The specific signature of the item is such that in order to identify the item, the receiver needs a special means, so that falsification/reproduction of the item is virtually impossible. The entire item-related data may be previously prepared by the item manufacturer and/or seller to be supplied together with the item. Alternatively, at least part of the information pieces to be included in the item-related data may be separately and previously prepared, allowing the purchaser to select one or more of them to form the item-related data and to be included in the purchase-related data.

The purchase-related data is analyzed and processed to create a predetermined output indicative of this data, formatted in the manner of the presentation of the output as selected by the purchaser.

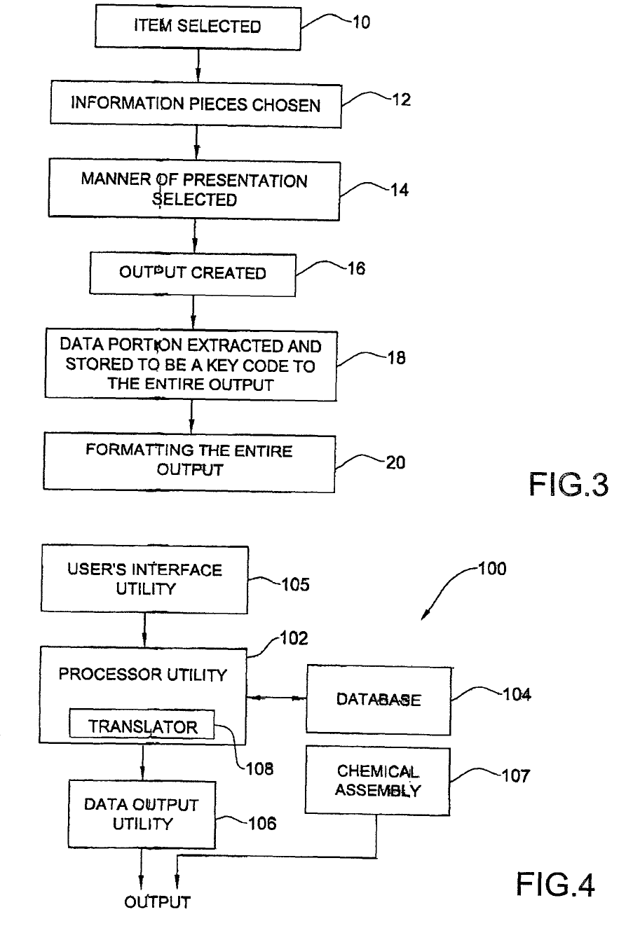

A method of selling items according to the invention will now be described with reference to FIG. 3. Thus, the purchaser selects an item (step 10), chooses information pieces to be included into the purchase-related data (step 12), and selects the manner in which corresponding output indicative of the purchase-related data is to be presented (step 14), as there exist several options of the data presentation. The data indicative of the purchaser's selections is then analyzed and processed to create the output representative of the purchase-related data (step 16).

For example, the purchaser may choose the output to be his favorite song or that of the item receiver for whom he purchases the item as a gift. Additionally, the purchaser may select a specific picture to accompany the song presentation. Obviously, both the song and the picture should be available in their digital representation, being accessible either from the seller's site or, when purchasing through a communication network (e.g., the Internet), from the purchaser's personal communication unit. The output is of the kind to be retrieved by means of a suitable data representing utility, which may and may not include a data output utility.

It should be noted that the data output may be such that different representations exist for different output devices, e.g., audio/video bitstreams. In all cases, the message is coded electronically. For example, an image (photo, video) related to the purchaser and/or receiver can be scanned/converted to a suitable format, so as to be includable into the electronically coded message.

In this specific example of FIG. 3, when the output is created, a portion thereof, indicative of only some of the information pieces included in the purchase-related data, is extracted and stored on an information carrier (step 18), which constitutes at least a part of the data representing utility. This stored portion will present a key code to the entire output. The entire output is appropriately formatted (step 20) to form a data package transmittable from the seller site (or corresponding WebSite) to the purchaser or receiver site (as the case may be) to be presented on the purchaser/receiver personal communication device, in response to input data indicative of the extracted portion of the output. For this purpose, any known encryption-decryption technique can, for example, be used.

In other words, when the information carrier is loaded in a computer device to which a data package containing the entire output has been transmitted, the retrieved extracted portion of the output will present a key code to access the entire output, thereby causing its presentation. For example, such a key code may include at least part (one or more information pieces) of the selected item-related data. Additionally, more than one key can be used to activate different messages from the bitstream, for example, to activate the different messages at different times.

The case may be such that a specific portion of the output, which is to be used as the key code, is prepared to be of the kind retrievable from the item itself (i.e., includes the item-related data), rather than being stored on the information carrier supplied together with the item, as will be described more specifically further below.

FIG. 4 schematically illustrates a system 100 for carrying out the method of the present invention. The system comprises a processor utility 102, a database 104, a user interface utility 105, a data output utility 106, and, optionally, a chemical assembly 107 for including a specific perfume into the predetermined output indicative of the purchase-related data. It should be understood that, if the inclusion of a perfume is considered, the item is purchased on the seller side, and a perfume processing utility is to be provided on the purchaser and/or receiver side, being, for example, a part of a presentation case in which the purchased item is supplied. The processor utility preferably also comprises a translator utility 108, the purposes of which will be described further below.

The database 104 may be located remotely from the other components of the system 100 (at one or more remote locations), accessible from the seller site through a communication network (e.g., the Internet). The user interface and processor utilities are operable to allow the purchaser to search in the database (mine the database) and make his selections. It should be understood that the databases are not necessarily mutually compatible (e.g., have different formats). The processor utility 102 may be installed with suitable software for constructing messages (output signal representative of the purchase-related data).

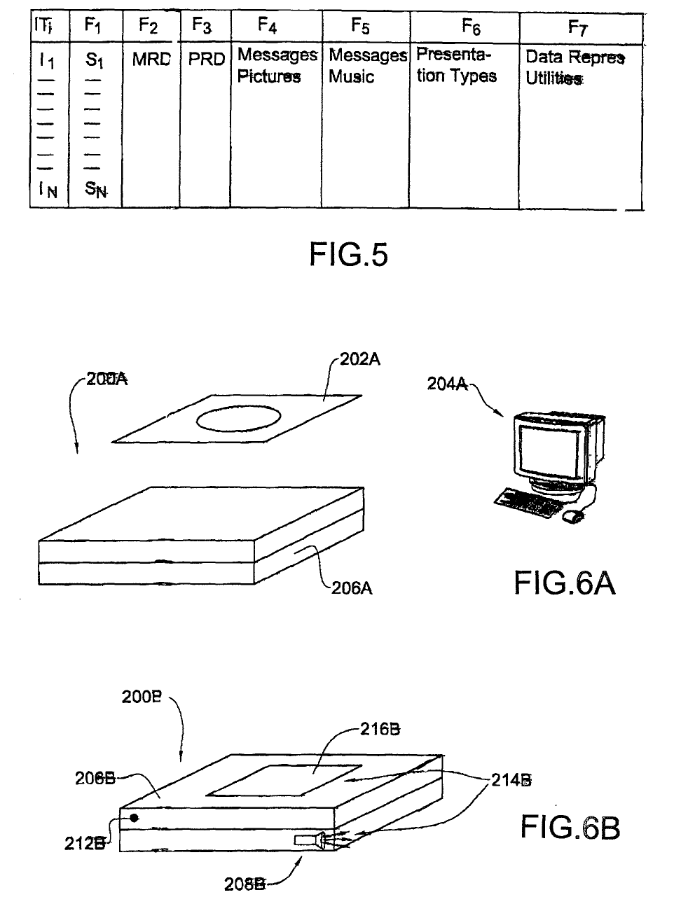

As shown more specifically in FIG. 5, the database 104 includes data fields—seven such fields F₁-F₇ in the present example. Fields F₁-F₃ contain various pieces of information associated with data relating to various items, generally at ITᵢ (i=1, . . . , N) available on the specific seller side. These data include specific signatures Sᵢ of the items, manufacturer-related data (MRD) that may and may not differ from item to item, and seller-related data (SRD). Fields F₄ and F₅ contain various types of, respectively, visual information pieces (messages, pictures) and audio information pieces (messages, music). Field F₆ contains various types of presentation of the selected pieces of information, namely, the time schedule of presentation: in response to the request of the purchaser/receiver (the request may be the receipt of a key code), or specifically defined periodic presentation. Field F₇ contains various types of data representing utilities, such as an information carrier (optical or magnetic disc) with the entire output or portion thereof stored therein, network transmission, printed copy of message and/or picture, or combination thereof. The data field F₇ actually allows the purchaser to choose the output device in order to compile the data selected from the database into an appropriate format. It should be noted that this data field F₇ may be part of the translator utility or the data output utility.

The user interface utility allows the purchaser to select one or more pieces of information to be included in the output, to add one or more information pieces chosen by him and not included in the database, and to select the manner of presentation of the entire purchase-related data (e.g., to select an option to use a key code based presentation), as well as a representation device (the presentation case in which the item is supplied and/or an external device such as a computer). For example, the purchaser may design a specific message he wishes to be presented to the item receiver, or enters his own or the item receiver's birthday and the current geographical location, thereby actuating the processor utility operable by suitable software to create an image of the corresponding astrological map showing the position of stars at this specific location and on this specific date. It should be understood that more than one message can be selected, depending on the representation device selected by the receiver. If the purchaser selects the key code based presentation, the processor utility defines a portion of the output to be extracted and stored as the key code and the way in which the entire output is presented in response to the key code.

It should be noted that the purchaser may select the entire purchase-related data or a portion thereof to be a picture of himself while purchasing the selected item. In this case, the seller simply makes a picture, and, in accordance with the purchaser's selection, either just supplies a print copy of the picture with the purchased item, or makes a digital copy of the picture (e.g., scans the picture or uses a digital camera to make a picture) to be presented at the purchaser/receiver computer (e.g., transmitted through a communication network).

The data output utility 106 includes a display and/or a speaker and/or tactile associated equipment enabling the presentation of the so-created output to the purchaser for his review to approve or amend his selections.

If the specific signature of the item is considered as part of the purchase-related data, for example, the item is a gemstone and the signature is the optical response of the gemstone, the processor utility also comprises the suitable translator utility 108. The latter translates the digital representation of the signature (bitmap in this specific example) stored in the database into audio and/or visual data representative thereof. Thus, the output may, for example, include the message “HAPPY BIRTHDAY”, music corresponding to the bitmap of the specific gemstone, and the astrological map (image) relating to the item receiver's birthday to be displayed. With respect to items of the kind characterized by specific optical responses, corresponding music may be stored in the database, and a suitable translator may allow various improvisations of the stored music in accordance with the purchaser's selection. This aspect is disclosed in WO 01/48463 assigned to the assignee of the present application, which is therefore incorporated herein by reference to this specific example of utilizing the optical response of a gemstone as part of the item-related data. The verification of the specific signature of the purchased item can be implemented either off-line (i.e., by using the signature retrieving system on the seller side) or on-line (the so-called “in-situ verification of the specific signature”) by using means provided in a presentation case containing the purchased item.

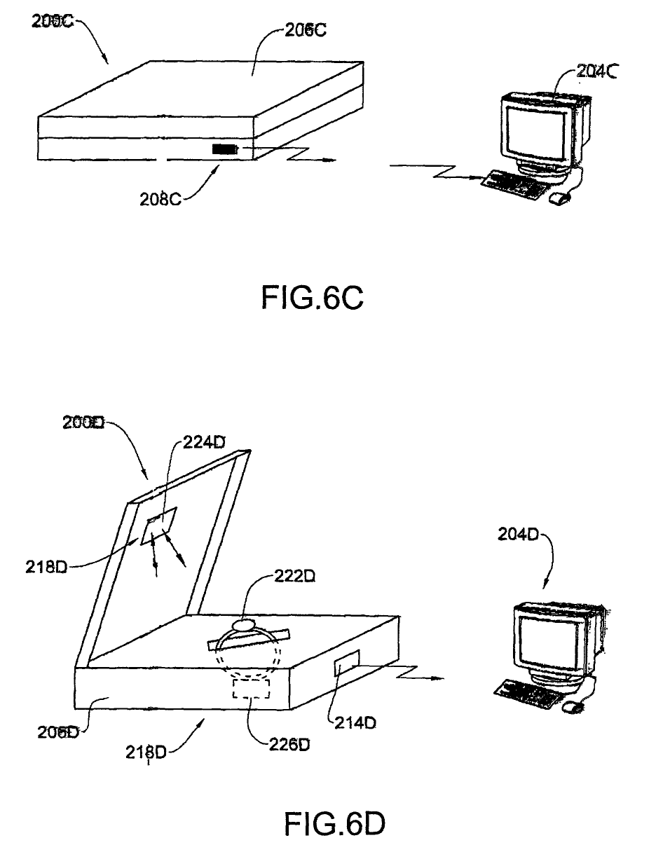

Reference is now made to FIGS. 6A-6D showing different examples of a presentation device to be received with the purchased item. In the example of FIG. 6A, a presentation device 200A comprises a data representing utility 202A in the form of an information carrier, such as a disc or card, with the output indicative of the purchase-related data stored therein to be retrieved at an external unit 204A (computer or audio CD player, as the case may be). Thus, the purchaser receives the selected item contained in presentation case 206A containing the purchased item (not shown) supplied with the data representing utility 202A, and allows the presentation of the output by loading the information carrier into the external data retrieving unit 204A.

In the example of FIG. 6B, a data presentation device 200B comprises a presentation case 206B that contains the purchased item (not shown) therein and is equipped with an electronic assembly 208B constituting a data representing utility. The electronic assembly includes an information carrier (chip with embedded application) which is not specifically shown, an actuator 212B (a push button in this specific example) and a data output utility 214B, which, in this specific example, includes both a speaker 215B and an LC display 216B. Thus, by pressing the button 212B, the electronic assembly is actuated to present the selected output indicative of the entire purchase-related data. It should be noted, although not specifically shown, that the electronic assembly may be actuated in response to the opening of the presentation case.

A presentation device 200C of FIG. 6C comprises a presentation case 206C that contains the purchased item, and a data representing utility 208C, which, in this specific example, comprises an electronic assembly of the kind producing an output signal indicative of a portion (key code) of the entire output representative of the purchase-related data. The electronic assembly comprises an information carrier with the data portion stored therein and an output utility which are not specifically shown. When the data representing utility 208C is appropriately actuated, it outputs the stored data as a signal suitable for communication with an external unit 204C (through wires, or wireless using RF or IR signals). In this case, as described above, the seller transmits the entire output to this specific external unit through a communication network, wherein this output is formatted to be “opened” in response to the key code. The key code may, for example, be indicative of the specific signature of the item.

In other words, the case may be such that the entire output (e.g., message) is contained in the external device, but it is only activated by the insertion of the key code. This key code can be previously prepared and stored to be externally supplied from the electronic assembly installed in the presentation case, identified/verified from a characteristic of the item in the presentation case, or created by an external verification means (e.g., at the seller side).

FIG. 6D illustrates an example of a presentation device 200D, in which a data representing utility 208D includes a verification assembly 218D, a data processing utility (not shown), and an output utility 214D mounted in a presentation case 206D. In this specific example, the purchased item is a gemstone 222D within a jewelry piece, and the verification assembly 218D comprises a measuring means (a detector) for measuring the parameters of the gemstone presenting the specific signature of the gemstone. This measuring means comprises a first measuring unit 224D (an optical system) for detecting the optical response of the gemstone, and a second measuring unit 226D (piezoelectric element) for measuring the weight of the gemstone. It should be noted that the optical system may alternatively or additionally be used for detecting an identification code presented on the gemstone (e.g., in the case of diamond, code written on the diamond's girdle or table). Measured data is processed by the data processing utility 220D that generates an output signal transmitted through the output utility 214D to a computer 204D. The entire output is formatted so as to enable the output presentation only if the measured data matches the specific signature of the purchased item, thereby enabling authentication of an item contained in the presentation case. It should be noted, although not specifically shown, that such a presentation case equipped with the verification assembly may include an information carrier with the entire output stored therein, and the output utility may be of the kind enabling presentation of the entire output indicative of the purchase-related data, in which case, the data processing utility is programmed to analyze the measured data.

Those skilled in the art will readily appreciate that various modifications and changes can be applied to the preferred embodiments of the invention as hereinbefore exemplified without departing from its scope defined in and by the appended claims.

1. A method of selling items, the method comprising the steps of:
(a) allowing a purchaser of a specific item for choosing information to be included in purchase-related data associated with this specific purchase, and for selecting a manner in which the purchase-related data is to be presented to the purchaser or another person for whom the item is being purchased; and
(b) creating at least one predetermined output representative of the purchase-related data and formatted in the manner of presentation thereof selected by the purchaser.

2. The method according to claim 1, wherein the choosing of the information to be included in the purchase-related data comprises selecting of one or more information pieces from at least one database containing reference data including various kinds of information pieces.

3. The method according to claim 2, wherein the at least one database is located remote from the purchaser current location and is accessible through a communication network.

4. The method according to claim 2, wherein more than one mutually incompatible database is used for choosing the information to be included in the purchase-related data, the creation of said at least one predetermined output comprises the step of combining the information pieces from the different databases.

5. The method according to claim 1, and also comprising the step of extracting from said predetermined output a data portion to be used as a key code to the entire predetermined output, thereby enabling the presentation of the entire predetermined output in response to said key code.

6. The method according to claim 5, wherein the extracted data portion contains information indicative of the selected item, thereby enabling identification or verification of the item.

7. The method according to claim 1, and also comprising the step of presenting the created predetermined output to the purchaser for his review to approve or amend his selections.

8. The method according to claim 1, wherein said predetermined output is formatted as a data package for storage in an information carrier readable by an external data-retrieving device.

9. The method according to claim 1, wherein the entire predetermined output is formatted as a data package readable by an external data-retrieving device.

10. The method according to claim 9, wherein said data package is formatted for transmission to the external data-retrieving device through a communication network.

11. The method according to claim 5, wherein the extracted portion of said predetermined output is formatted as a first data package for storage in a data representing utility to be supplied with a presentation case containing the purchased item therein, the entire predetermined output being formatted as a second data package readable by an external data-retrieving device in response to a signal generated by the data representing utility and indicative of said extracted data portion.

12. The method according to claim 11, wherein said second data package is formatted for transmission to the external data-retrieving device through a communication network.

13. The method according to claim 1, and also comprising the step of allowing the purchaser or another person for whom the item has been purchased to verify whether the item contained in a presentation case is that selected by the purchaser.

14. The method according to claim 13, wherein the verification comprises detecting at least one character of the item contained in the presentation case and generating data indicative thereof, and, if the generated data matches the corresponding character of the selected item, said generated data presents a key code to the entire predetermined output representative of the purchase-related data.

15. The method according to claim 14, wherein said detecting of the at least one character of the item and analyzing of the generated data to determined whether it matches the corresponding character of the selected item are performed by a detector and a data processing utility, respectively, both installed in the presentation case, and the presentation of the entire predetermined output from an external data-retrieving device is actuated in response to said key-code generated by an output utility installed in the presentation case.

16. The method according to claim 15, wherein said detecting of the at least one character of the item and generation of a signal indicative thereof is performed by a detector installed in the presentation case, analyzing of the generated signal to determined whether it matches the corresponding character of the selected item and generation of the key code being performed by a data processing utility of an external data-retrieving device, which presents the entire predetermined output in response to the key code.

17. A system for selling items comprising:
(a) a user interface utility enabling a purchaser to define information which is to be included in purchase-related data associated with a specific purchase of an item selected by a purchaser of the item; and
(b) a data processing utility for creating a predetermined output representative of the purchase-related data in accordance with the defined information, and formatting the output in the manner of presentation thereof selected by the purchaser.

18. The system according to claim 17, and also comprising at least one database containing various information pieces for selecting by the purchaser at least one of the information pieces to be included into the purchase-related data.

19. The system according to claim 18, wherein said information pieces include information indicative of at least one of the following: item-related data, item manufacturer related data, and item seller related data.

20. The system according to claim 19, wherein the item-related data includes a specific signature of the item.

21. The system according to claim 20, and also comprising a chemical assembly enabling the purchaser to select a scent to be added to the presentation of the predetermined output.

22. A device for presentation of a purchased item to be supplied to a purchaser of the item, the device comprising a data representing utility operable to cause generation of a predetermined output or a portion thereof, wherein said predetermined output is representative of predetermined purchase-related data that has been chosen by the purchaser of the item.

23. The device according to claim 22, wherein the data representing utility comprises an information carrier that carries at least a portion of the predetermined output stored therein to be readable by a data retrieving device.

24. A presentation case for containing a purchased item, the presentation case being provided with a data representing utility operable to cause generation of a predetermined output or a portion thereof, wherein said predetermined output is representative of purchase-related data that has been chosen by the purchaser of the item.

25. The presentation case according to claim 24, wherein said data representing utility comprises an information carrier carrying at least a portion of the predetermined output stored therein to be readable by a data-retrieving device.

26. The presentation case according to claim 25, wherein the data representing utility comprises an electronic assembly including an information carrier with a data portion of said predetermined output stored therein, and an actuator for generating an output signal indicative of said data portion, said output signal being for actuating the presentation of the entire predetermined output at an external data-retrieving device.

27. The presentation case according to claim 25, wherein the data representing utility comprises a verification assembly, a data processing utility, and an output utility, the verification assembly comprising a measuring means for determining at least one character of the item contained in the presentation case and generating data indicative thereof to be processed by the data processing utility for generating an output signal transmitted through the output utility to an external device for presentation of the entire predetermined output, if the data indicative of the measured character matches a specific data portion of the entire output.
